(19) United States
(12) Patent Application Publication
(10) Pub. No.: US 2017/0168729 A1
(43) Pub. Date: Jun. 15, 2017

(54) METHODS AND SYSTEMS FOR MANAGING RESOURCES OF A NETWORKED STORAGE ENVIRONMENT

(71) Applicant: NETAPP, INC., Sunnyvale, CA (US)

(72) Inventors: Kevin Faulkner, Westford, MA (US); Joseph Weihs, Arlington, MA (US)

(73) Assignee: NETAPP, INC., Sunnyvale, CA (US)

(21) Appl. No.: 14/966,249

(22) Filed: Dec. 11, 2015

(51) Int. Cl. G06F 3/06

(52) U.S. Cl. CPC G06F 3/0613; G06F 3/0665; G06F 3/067; G06F 3/0631

(57) ABSTRACT

Methods and systems for a networked storage system are provided. One method includes receiving a request for configuring a workload by a processor executing a management application in a networked storage system, the request including a tag with information for identifying a workload type and information defining an expected performance characteristic of the workload; determining by the processor a comparable workload using the tag information; obtaining by the processor current and historical performance data associated with the comparable workload; estimating by the processor performance characteristic of the requested workload using performance data of the comparable workload; identifying by the processor a resource of the networked storage system that meets the estimated performance characteristic; and allocating by the processor the resource to the requested workload.

### TECHNICAL FIELD

The present disclosure relates to monitoring and managing networked storage system resources.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple clients with access to shared data, backing up data and others.

A storage system typically includes at least a computing system executing a storage operating system for storing and retrieving data on behalf of one or more client computing systems (may be referred to as “client” or “clients”). The storage operating system stores and manages shared data containers in a set of mass storage devices.

Quality of Service (QOS) is used in a storage environment to provide certain throughput in processing input/output (I/O) requests, a response time goal within, which I/O requests are processed and a number of I/O requests processed within a given time (for example, in a second (IOPS). Throughput means an amount of data transferred within a given time in response to the I/O requests, for example, in megabytes per second (Mb/s). Different QOS levels may be provided to different clients depending on service level objectives.

To process an I/O request to read and/or write data, various resources are used within a storage system, for example, network resources, processors, storage devices and others. The different resources perform various functions for processing the I/O requests.

As storage systems continue to expand in size and operating speeds, it is desirable to efficiently monitor resource usage within the storage system and allocate proper resources to meet user expectations and service levels. Continuous efforts are being made to efficiently allocate storage system resources.

### BRIEF DESCRIPTION OF THE DRAWINGS

The various features of the present disclosure will now be described with reference to the drawings of the various aspects. In the drawings, the same components may have the same reference numerals. The illustrated aspects are intended to illustrate, but not to limit the present disclosure. The drawings include the following Figures:

FIG. 1 shows an example of a networked storage operating environment for the various aspects disclosed herein;

FIG. 2A shows an example of a clustered storage system in a networked storage operating environment, according to one aspect of the present disclosure;

FIG. 2B shows an example of a computing device (performance manager) for monitoring storage system resources, according to one aspect of the present disclosure;

FIG. 3 shows an example of handling QOS (Quality of Service) requests by a storage system, according to one aspect of the present disclosure;

FIG. 4 shows an example of managing workloads and resources by the performance manager, according to one aspect of the present disclosure;

FIG. 5 shows an example of a resource layout used by the performance manager, according to one aspect of the present disclosure;

FIG. 6A shows a process flow diagram, according to the various aspects of the present disclosure;

FIG. 6B shows an example of a data structure, used according to one aspect of the present disclosure;

FIG. 7 shows an example of a storage system node, used according to one aspect of the present disclosure;

FIG. 8 shows an example of a storage operating system, used according to one aspect of the present disclosure; and

FIG. 9 shows an example of a processing system, used according to one aspect of the present disclosure.

### DETAILED DESCRIPTION

As a preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a hardware processor, a hardware based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device, in accordance with the claimed subject matter.

In one aspect, a performance manager module is provided that interfaces with a storage operating system to collect quality of service (QOS) data. QOS provides a certain throughput (i.e. data transfer within a given time interval), latency and/or a number of input/output operations that can be processed within a time interval, for example, in a second (referred to as IOPS). Latency means a delay in completing the processing of an I/O request and may be measured using different metrics for example, a response time in processing I/O requests.

The storage system uses various resources to process I/O requests for writing and reading data to and from storage devices. The storage system maintains various counters and data measurement objects (QOS data) for providing QOS to clients. The QOS data may include throughput data, a number of IOPS in a measurement period, and an average response time within the measurement period, a service time per visit to a resource, a wait time per visit to the resource and a number of visits at the resource used for processing I/O requests.

In response to configure a new workload or move an existing workload, the performance manager uses current and historical QOS data of a comparable workload obtained from the storage system to predict an expected performance of the requested workload. Based on the expected performance, appropriate storage resources are allocated.

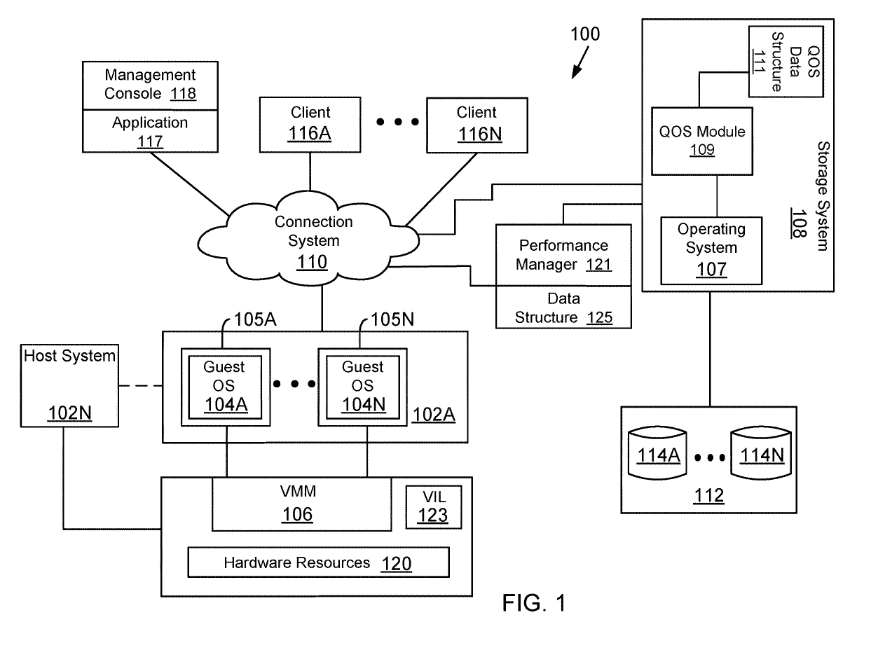

System 100: FIG. 1 shows an example of a system 100, where the adaptive aspects disclosed herein may be implemented. System 100 includes a performance manager 121 that interfaces with a storage operating system 107 of a storage system 108 for receiving QOS data. The performance manager 121 may be a stand-alone computing device or integrated with other devices.

The performance manager 121 obtains the QOS data and stores it at a local data structure 125. In one aspect, performance manager 121 receives a request for configuring a new workload, determines comparable workloads, predicts the performance of the requested workload and allocates an appropriate resource for servicing the workload. Details regarding the performance manager 121 are provided below.

In one aspect, storage system 108 has access to a set of mass storage devices 114A-114N (may be referred to as storage devices 114 or simply as storage device 114) within at least one storage subsystem 112. The storage devices 114 may include writable storage device media such as magnetic disks, video tape, optical, DVD, magnetic tape, non-volatile memory devices for example, solid state drives (SSDs) including self-encrypting drives, flash memory devices and any other similar media adapted to store information. The storage devices 114 may be organized as one or more groups of Redundant Array of Independent (or Inexpensive) Disks (RAID). The various aspects disclosed herein are not limited to any particular storage device type or storage device configuration.

In one aspect, the storage system 108 provides a set of logical storage volumes (may be interchangeably referred to as volume or storage volume) for providing physical storage space to clients 116A-116N (or virtual machines (VMs) 105A-105N). A storage volume is a logical storage object and typically includes a file system in a NAS environment or a logical unit number (LUN) in a SAN environment. The aspects described herein are not limited to any specific format in which physical storage is presented as logical storage (volume, LUNs and others)

Each storage volume may be configured to store data files (or data containers or data objects), scripts, word processing documents, executable programs, and any other type of structured or unstructured data. From the perspective of one of the client systems, each storage volume can appear to be a single drive. However, each storage volume can represent storage space in at one storage device, an aggregate of some or all of the storage space in multiple storage devices, a RAID group, or any other suitable set of storage space.

A storage volume is identified by a unique identifier (Volume-ID) and is allocated certain storage space during a configuration process. When the storage volume is created, a QOS policy may be associated with the storage volume such that requests associated with the storage volume can be managed appropriately. The QOS policy may be a part of a QOS policy group (referred to as “Policy_Group”) that is used to manage QOS for several different storage volumes as a single unit. The QOS policy information may be stored at a QOS data structure 111 maintained by a QOS module 109. QOS at the storage system level may be implemented by the QOS module 109. QOS module 109 maintains various QOS data types that are monitored and analyzed by the performance manager 121, as described below in detail.

The storage operating system 107 organizes physical storage space at storage devices 114 as one or more “aggregate”, where each aggregate is a logical grouping of physical storage identified by a unique identifier and a location. The aggregate includes a certain amount of storage space that can be expanded. Within each aggregate, one or more storage volumes are created whose size can be varied. A qtree, sub-volume unit may also be created within the storage volumes. For QOS management, each aggregate and the storage devices within the aggregates are considered as resources that are used by storage volumes.

The storage system 108 may be used to store and manage information at storage devices 114 based on an I/O request. The request may be based on file-based access protocols, for example, the Common Internet File System (CIFS) protocol or Network File System (NFS) protocol, over the Transmission Control Protocol/Internet Protocol (TCP/IP). Alternatively, the request may use block-based access protocols, for example, the Small Computer Systems Interface (SCSI) protocol encapsulated over TCP (iSCSI) and SCSI encapsulated over Fibre Channel (FCP).

In a typical mode of operation, a client (or a VM) transmits one or more I/O request, such as a CFS or NFS read or write request, over a connection system 110 to the storage system 108. Storage operating system 107 receives the request, issues one or more I/O commands to storage devices 114 to read or write the data on behalf of the client system, and issues a CIFS or NFS response containing the requested data over the network 110 to the respective client system.

System 100 may also include a virtual machine environment where a physical resource is time-shared among a plurality of independently operating processor executable VMs. Each VM may function as a self-contained platform, running its own operating system (OS) and computer executable, application software. The computer executable instructions running in a VM may be collectively referred to herein as “guest software.” In addition, resources available within the VM may be referred to herein as “guest resources.”

The guest software expects to operate as if it were running on a dedicated computer rather than in a VM. That is, the guest software expects to control various events and have access to hardware resources on a physical computing system (may also be referred to as a host platform or host system) which maybe referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host system.

In one aspect, system 100 may include a plurality of computing systems 102A-102N (may also be referred to individually as host platform/system 102 or simply as server 102) communicably coupled to the storage system 108 executing via the connection system 110 such as a local area network (LAN), wide area network (WAN), the Internet or any other interconnect type. As described herein, the term “communicably coupled” may refer to a direct connection, a network connection, a wireless connection or other connections to enable communication between devices.

Host system 102A includes a processor executable virtual machine environment having a plurality of VMs 105A-105N that may be presented to client computing devices/systems 116A-116N. VMs 105A-105N execute a plurality of guest OS 104A-104N (may also be referred to as guest OS 104) that share hardware resources 120. As described above, hardware resources 120 may include processors, memory, I/O devices, storage or any other hardware resource.

In one aspect, host system 102 interfaces with a virtual machine monitor (VMM) 106, for example, a processor executed Hyper-V layer provided by Microsoft Corporation of Redmond, Was., a hypervisor layer provided by VMWare Inc., or any other type. VMM 106 presents and manages the plurality of guest OS 104A-104N executed by the host system 102. The VMM 106 may include or interface with a virtualization layer (VIL) 123 that provides one or more virtualized hardware resource to each OS 104A-104N.

In one aspect, VMM 106 is executed by host system 102A with VMs 105A-105N. In another aspect, VMM 106 may be executed by an independent stand-alone computing system, often referred to as a hypervisor server or VMM server and VMs 105A-105N are presented at one or more computing systems.

It is noteworthy that different vendors provide different virtualization environments, for example, VMware Corporation, Microsoft Corporation and others. The generic virtualization environment described above with respect to FIG. 1 may be customized to implement the aspects of the present disclosure. Furthermore, VMM 106 (or VIL 123) may execute other modules, for example, a storage driver, network interface and others, the details of which are not germane to the aspects described herein and hence have not been described in detail.

System 100 may also include a management console 118 that executes a processor executable management application 117 for managing and configuring various elements of system 100. Application 117 may be used to manage and configure VMs and clients as well as configure resources that are used by VMs/clients, according to one aspect. It is noteworthy that although a single management console 118 is shown in FIG. 1, system 100 may include other management consoles performing certain functions, for example, managing storage systems, managing network connections and other functions described below.

In one aspect, application 117 may be used to present storage space that is managed by storage system 108 to clients' 116A-116N (or VMs). The clients may be grouped into different service levels, where a client with a higher service level may be provided with more storage space than a client with a lower service level. A client at a higher level may also be provided with a certain QOS vis-à-vis a client at a lower level.

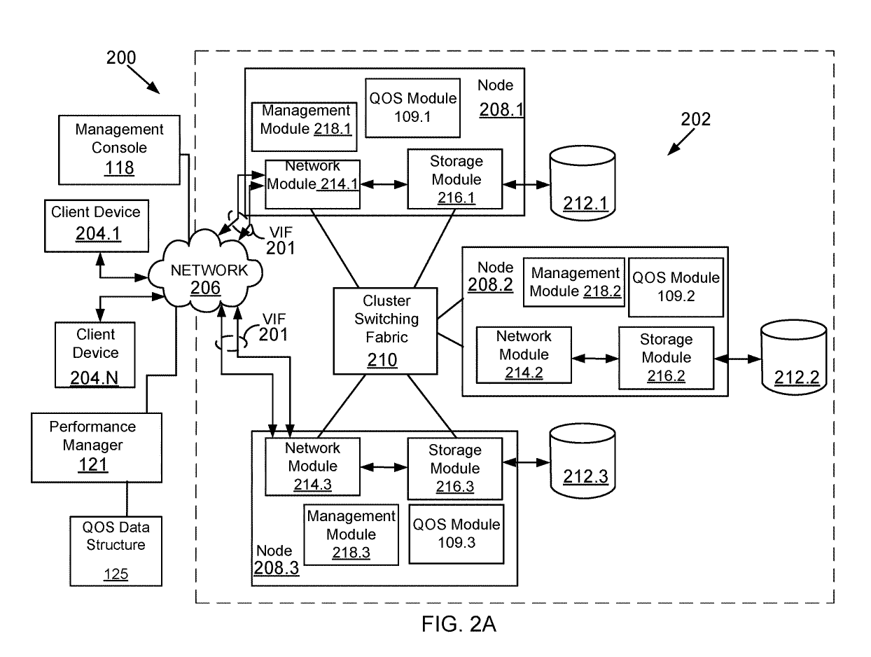

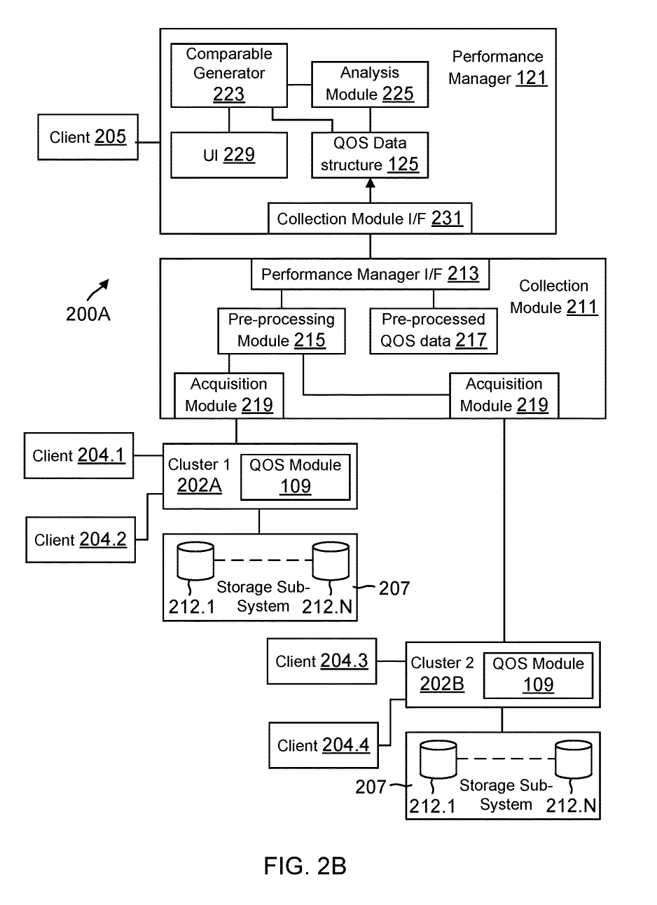

Although storage system 108 is shown as a stand-alone system, i.e. a non-cluster based system, in another aspect, storage system 108 may have a distributed architecture; for example, a cluster based system of FIG. 2A. Before describing the various aspects of the performance manager 121, the following provides a description of a cluster based storage system.

Clustered Storage System: FIG. 2A shows a cluster based, networked storage environment 200 having a plurality of nodes for managing storage devices, according to one aspect. Storage environment 200 may include a plurality of client systems 204.1-204.N (similar to clients 116A-116N, FIG. 1), a clustered storage system 202, performance manager 121, management console 118 and at least a network 206 communicably connecting the client systems 204.1-204.N and the clustered storage system 202.

The clustered storage system 202 includes a plurality of nodes 208.1-208.3, a cluster switching fabric 210, and a plurality of mass storage devices 212.1-212.3 (may be referred to as 212 and similar to storage device 114).

Each of the plurality of nodes 208.1-208.3 is configured to include a network module, a storage module, and a management module, each of which can be implemented as a processor executable module. Specifically, node 208.1 includes a network module 214.1, a storage module 216.1, and a management module 218.1, node 208.2 includes a network module 214.2, a storage module 216.2, and a management module 218.2, and node 208.3 includes a network module 214.3, a storage module 216.3, and a management module 218.3.

The network modules 214.1-214.3 include functionality that enable the respective nodes 208.1-208.3 to connect to one or more of the client systems 204.1-204.N over the computer network 206, while the storage modules 216.1-216.3 connect to one or more of the storage devices 212.1-212.3. Accordingly, each of the plurality of nodes 208.1-208.3 in the clustered storage server arrangement provides the functionality of a storage server.

The management modules 218.1-218.3 provide management functions for the clustered storage system 202. The management modules 218.1-218.3 collect storage information regarding storage devices 212.

Each node may execute or interface with a QOS module, shown as 109.1-109.3 that is similar to the QOS module 109. The QOS module 109 may be executed for each node or a single QOS module may be used for the entire cluster. The various aspects disclosed herein are not limited to the number of instances of QOS module 109 that may be used in a cluster. Details regarding QOS module 109 are provided below.

A switched virtualization layer including a plurality of virtual interfaces (VIFs) 201 is provided to interface between the respective network modules 214.1-214.3 and the client systems 204.1-204.N, allowing storage 212.1-212.3 associated with the nodes 208.1-208.3 to be presented to the client systems 204.1-204.N as a single shared storage pool.

The clustered storage system 202 can be organized into any suitable number of virtual servers (also referred to as “vservers” or storage virtual machines (SVMs)), in which each vserver represents a single storage system namespace with separate network access. Each vserver has a client domain and a security domain that are separate from the client and security domains of other vservers. Moreover, each vserver is associated with one or more VIFs and can span one or more physical nodes, each of which can hold one or more VIFs and storage associated with one or more vservers. Client systems can access the data on a vserver from any node of the clustered system, through the VIFs associated with that vserver. It is noteworthy that the aspects described herein are not limited to the use of vservers.

Each of the nodes 208.1-208.3 is defined as a computing device to provide application services to one or more of the client systems 204.1-204.N. The nodes 208.1-208.3 are interconnected by the switching fabric 210, which, for example, may be embodied as a Gigabit Ethernet switch or any other type of switching/connecting device.

Although FIG. 2A depicts an equal number (i.e. 3) of the network modules 214.1-214.3, the storage modules 216.1-216.3, and the management modules 218.1-218.3, any other suitable number of network modules, storage modules, and management modules may be provided. There may also be different numbers of network modules, storage modules, and/or management modules within the clustered storage system 202. For example, in alternative aspects, the clustered storage system 202 may include a plurality of network modules and a plurality of storage modules interconnected in a configuration that does not reflect a one-to-one correspondence between the network modules and storage modules.

Each client system 204.1-204.N may request the services of one of the respective nodes 208.1, 208.2, 208.3, and that node may return the results of the services requested by the client system by exchanging packets over the computer network 206, which may be wire-based, optical fiber, wireless, or any other suitable combination thereof.

Performance manager 121 interfaces with the various nodes and obtains QOS data for QOS data structure 125. Details regarding the various modules of performance manager are now described with respect to FIG. 2B.

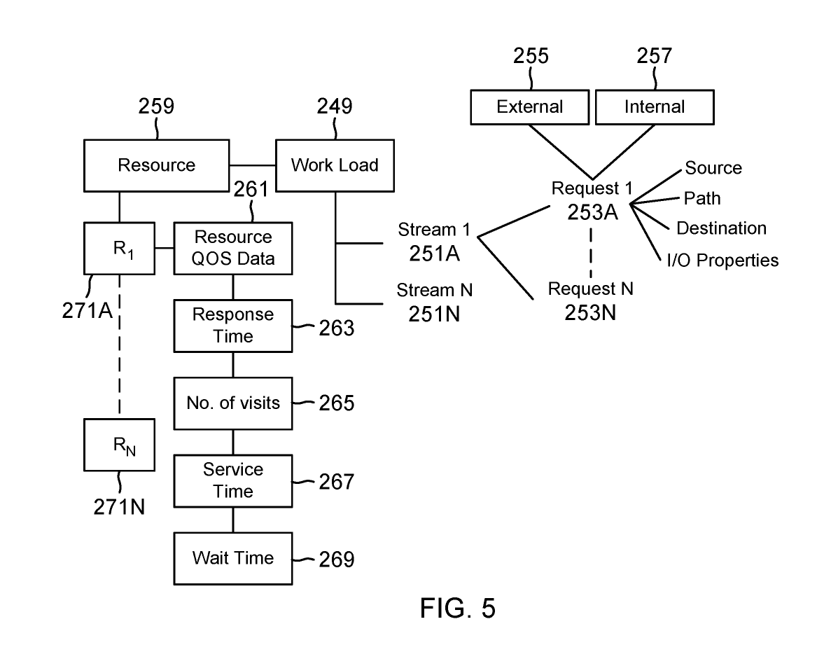

Performance Manager 121: FIG. 2B shows a block diagram of system 200A with details regarding performance manager 121 and a collection module 211, according to one aspect. Performance manager 121 uses the concept of workloads for configuring resources of a networked storage environment. At a high level, workloads are defined based on incoming input/output (I/O) requests (i.e. read and write requests) and use resources within storage system 202 for processing I/O requests. A workload may include a plurality of streams, where each stream includes one or more requests issued by clients. A stream may include requests from one or more clients. An example, of the workload model used by performance manager 121 is shown in FIG. 5 and described below in detail.

Performance manager 121 collects a certain minimal amount of data (for example, QOS data for 3 hours or 30 data samples) of workload activity. After collecting the minimal QOS data, performance manager 121 generates an expected range (or threshold values) predicting future behavior of the QOS data.

The expected range is a range of measured performance activity (or QOS data) of a workload over a period of time. For example, a given twenty-four hour period may be split into multiple time intervals. The expected range may be generated for each time interval. The expected range sets a baseline for what may be perceived to be typical activity for the workload. The upper boundary of the expected range establishes a dynamic performance threshold that changes over time. For example, during 9.00 AM and 5.00 PM most employees of a business check their email between 9.00 AM-10.30 AM. The increased demand on email servers means an increase in the workload activity at the storage managed by the storage operating system. The demand on the storage may decrease during lunch time. The performance manager 121 tracks this activity to find comparable workloads when a new workload is requested or if a workload has to be moved from one volume to another volume.

System 200A shows two clusters 202A and 202B, both similar to cluster 202 described above. Each cluster includes the QOS module 109 for implementing QOS policies that are established for different clients/applications.

Cluster 1 202A may be accessible to clients 204.1 and 204.2, while cluster 2 202B is accessible to clients 204.3/204.4. Both clusters have access to storage subsystems 207 and storage devices 212.1/212.N.

Clusters 202A and 202B communicate with a collection module 211. The collection module 211 may be a standalone computing device or integrated with the performance manager 121. The aspects described herein are not limited to any particular configuration of collection module 211 and performance manager 121.

Collection module 211 includes one or more acquisition modules 219 for collecting QOS data from the clusters. The data is pre-processed by the pre-processing module 215 and stored as pre-processed QOS data 217 at a storage device (not shown). Pre-processing module 215 formats the collected QOS data for the performance manager 121. Pre-processed QOS data 217 is provided to a collection module interface 231 of the performance manager 121 via a performance manager interface 213. QOS data received from collection module 211 is stored at QOS data structure 125 by performance manager 121 at a storage device (not shown).

Performance manager 121 includes a plurality of modules, for example, an analysis module 225 that analyzes QOS data 125 and a comparable generator 223 that parses a request for a new workload or for moving a workload from one resource to another, finds a comparable workload and uses the performance data of the comparable workload to predict the performance associated with the requested workload.

In one aspect, the request for the new workload may be received by a user interface module 229 that presents a GUI or a command line interface (CLI) to client 205. In one aspect, the request includes a tag that identifies a workload type and/or a service level objective. Using the tag, the comparable generator 223 identifies similar workloads. The analysis module 225 predicts the performance of the requested workload using historical and current performance data for the comparable workloads. The predicted performance is then used to allocate appropriate resources.

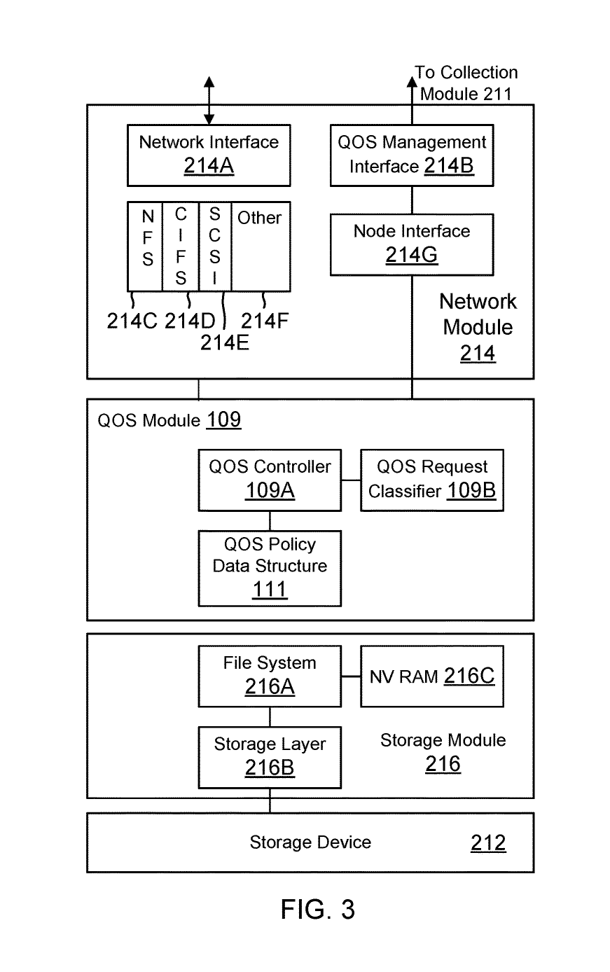

QOS Infrastructure: Before describing the various processes executed by the performance manager 121, the following describes how QOS requests are handled at the cluster level with respect to FIG. 3. The network module 214 of a cluster node includes a network interface 214A for receiving requests from clients. The network module 214 executes a NFS module 214C for handling NFS requests, a CIFS module 214D for handling CIFS requests, a SCSI module 214E for handling iSCSI requests and an others module 214F for handling “other” requests. A node interface 214G is used to communicate with QOS module 109, storage module 216 and/or another network module 214. QOS management interface 214B is used to provide QOS data from the cluster to collection module 211 for pre-processing.

QOS module 109 includes a QOS controller 109A, a QOS request classifier 109B and QOS policy data structure (or Policy Group) 111. The QOS policy data structure 111 stores policy level details for implementing QOS for clients and storage volumes. The policy determines what latency and throughput rate is permitted for a client as well as for specific storage volumes. The policy determines how I/O requests are processed for different volumes and clients.

The storage module 216 executes a file system 216A (a part of storage operating system 107 described below) and includes a storage layer 216B to interface with storage device 212. NVRAM 216C of the storage module 216 may be used as cache for responding to I/O requests.

A request arrives at network module 214 from a client or from an internal process directly to file system 216A. Internal process in this context may include a de-duplication module, a replication engine module or any other entity that needs to perform a read and/or write operation at the storage device 212. The request is sent to the QOS request classifier 109B to associate the request with a particular workload. The classifier 109B evaluates a request's attributes and looks for matches within QOS policy data structure 111. The request is assigned to a particular workload, when there is a match. If there is no match, then a default workload may be assigned.

Once the request is classified for a workload, then the request processing can be controlled. QOS controller 109A determines if a rate limit (i.e. a throughput rate) for the request has been reached. If yes, then the request is queued for later processing. If not, then the request is sent to file system 216A for further processing with a completion deadline. The completion deadline is tagged with a message for the request.

File system 216A determines how queued requests should be processed based on completion deadlines. The last stage of QOS control for processing the request occurs at the physical storage device level. This could be based on latency with respect to storage device 212 or for NVRAM 216C that may be used for any logged operation.

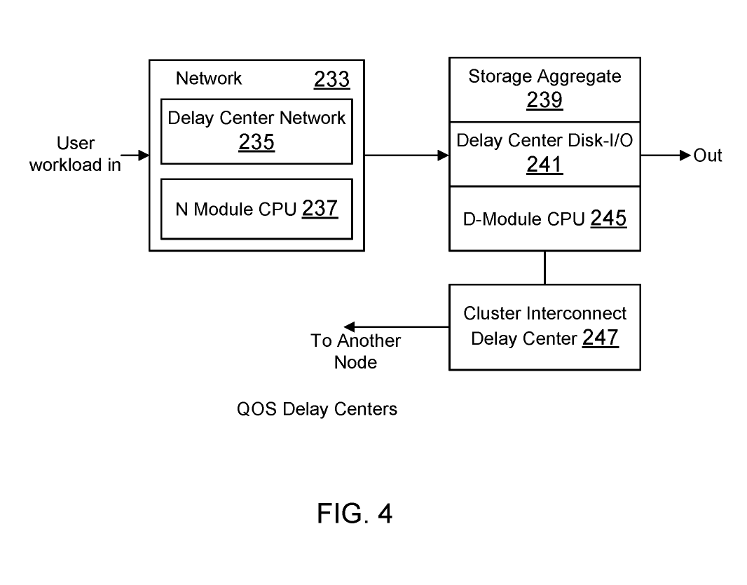

Queuing Network: FIG. 4 shows an example of a queuing network used by the performance manager 121, according to one aspect. A user workload enters the queuing network from one end (i.e. at 233) and leaves at the other end.

Various resources are used to process I/O requests. As an example, there are may be two types of resources, a service center and a delay center resource. The service center is a resource category that can be represented by a queue with a wait time and a service time (for example, a processor that processes a request out of a queue). The delay center may be a logical representation for a control point where a request stalls waiting for a certain event to occur and hence the delay center represents the delay in request processing. The delay center may be represented by a queue that does not include service time and instead only represents wait time. The distinction between the two resource types is that for a service center, the QOS data includes a number of visits, wait time per visit and service time per visit for incident detection and analysis. For the delay center, only the number of visits and the wait time per visit at the delay center are used, as described below in detail.

Performance manager 121 uses different flow types for analysis. A flow type is a logical view for modeling request processing from a particular viewpoint. The flow types include two categories, latency and utilization. A latency flow type is used for analyzing how long operations take at the service and delay centers. The latency flow type is used to identify a victim workload whose latency has increased beyond a certain level. A typical latency flow may involve writing data to a storage device based on a client request and there is latency involved in writing the data at the storage device. The utilization flow type is used to understand resource consumption of workloads and may be used to identify resource contention and a bully workload as described below in detail.

Referring now to FIG. 4, delay center network 235 is a resource queue that is used to track wait time due to external networks. Storage operating system 107 often makes calls to external entities to wait on something before a request can proceed. Delay center 235 tracks this wait time.

Network module CPU 237 is another resource queue where I/O requests wait for protocol processing by a network module processor. A separate queue for each node may be maintained.

A storage aggregate (or aggregate) 239 is a resource that may include more than one storage device for reading and writing information. Disk-I/O 241 queue may be used to track utilization of storage devices 212. A storage module CPU 245 represents a processor that is used to read and write data. The storage module CPU 245 is a service center and a queue is used to track the wait time for any writes to storage devices by a storage module processor.

Nodes within a cluster communicate with each other. These may cause delays in processing I/O requests. The cluster interconnect delay center 247 is used to track the wait time for transfers using the cluster interconnect system. As an example, a single queue maybe used to track delays due to cluster interconnects.

There may also be delay centers due to certain internal processes of storage operating system 107 and various queues may be used to track those delays. For example, a queue may be used to track the wait for I/O requests that may be blocked for file system reasons. Another queue (Delay_Center_Susp_CP) may be used to represent the wait time for Consistency Point (CP) related to the file system 216A. During a CP, write requests are written in bulk at storage devices and this will typically cause other write requests to be blocked so that certain buffers are cleared.

Workload Model: FIG. 5 shows an example, of the workload model used by performance manager 121, according to one aspect. As an example, a workload may include a plurality of streams 251A-251N. Each stream may have a plurality of requests 253A-253N. The requests may be generated by any entity, for example, an external entity 255, like a client system and/or an internal entity 257, for example, a replication engine that replicates storage volumes at one or more storage location.

A request may have a plurality of attributes, for example, a source, a path, a destination and I/O properties. The source identifies the source from where a request originates, for example, an internal process, a host or client address, a user application and others. The path defines the entry path into the storage system. For example, a path may be a logical interface (LIF) or a protocol, such as NFS, CIFS, iSCSI and Fibre Channel protocol.

A destination is the target of a request, for example, storage volumes, LUNs, data containers and others.

I/O properties include operation type (i.e. read/write/other), request size and any other property.

In one aspect, streams may be grouped together based on client needs. For example, if a group of clients make up a department on two different subnets, then two different streams with the “source” restrictions can be defined and grouped within the same workload. Furthermore, requests that fall into a workload are tracked together by performance 121 for efficiency. Any requests that don't match a user or system defined workload may be assigned to a default workload.

In one aspect, workload streams may be defined based on the I/O attributes. The attributes may be defined by clients. Based on the stream definition, performance manager 121 tracks workloads.

Referring back to FIG. 5, a workload uses one or more resources for processing I/O requests shown as 271A-271N as part of a resource object 259. For each resource, a queue is maintained for tracking different statistics (or QOS data) 261. For example, a response time 263, and a number of visits 265, a service time (for service centers) 267 and a wait time 269 are tracked. The term QOS data as used throughout this specification includes one or more of 263, 265, 267 and 269 according to one aspect.

Without limiting the various aspects of the present disclosure, Table I below provides an example of a non-exhaustive listing of the various objects that are used by the performance manager 121 for tracking performance data:

TABLE I

| Object | Instance | Purpose | Description |
|---|---|---|---|
| Workload | <workload_name> | Represents an external workload | Throughput, Average |
| | | applied to a volume. The object | response time |
| | | may be used to measure workload | |
| | | performance against service | |
| | | levels. | |
| Resource | <resource_name> | Provide hierarchical utilization | Utilization |
| | | of resources and may be a | |
| | | service or delay center. | |
| Resource_detail | <resource_name>. | Breakdowns resource usage by | Utilization |
| | <workload_name> | workload from a resource | |
| | | perspective. | |
| Workload_detail | <workload_name>. | Breakdowns workload response | Number of visits, |
| | <service_center_name> | time by resource. | service time per |
| | | | visit and wait time |
| | | | per visit |

Performance manager 121 also uses a plurality of counter objects for performance analysis. Without limiting the adaptive aspects, an example of the various counter objects are shown and described in Table II below:

TABLE II

| Workload Object Counters | Description |
|---|---|
| Ops | A number of workload's operations that are completed during a |
| | measurement interval, for example, a second. |
| Read_ops | A number of workload read operations that are completed during |
| | the measurement interval. |
| Write_ops | A number of workload write operations that are completed |
| | during the measurement interval. |
| Total_data | Total data read and written per second by a workload. |
| Read_data | The data read per second by a workload. |
| Write_data | The data written per second by a workload. |
| Latency | The average response time for I/O requests that were initiated |
| | by a workload. |
| Read_latency | The average response time for read requests that were |
| | initiated by a workload. |
| Write_latency | The average response time for write requests that were |
| | initiated by a workload. |
| Latency_hist | A histogram of response times for requests that were initiated |
| | by a workload. |
| Read_latency_hist | A histogram of response times for read requests that were |
| | initiated by a workload. |
| Write_latency_hist | A histogram of response times for write requests that were |
| | initiated by a workload. |
| Wid | A workload identifier. |
| Classified | Requests that were classified as part of a workload. |
| Read_IO_type | The percentage of reads served from various components (for |
| | example, buffer cache, ext_cache or disk). |
| Concurrency | Average number of concurrent requests for a workload. |
| Interarrival_time_sum_squares | Sum of the squares of the Inter-arrival time for requests of a |
| | workload. |
| Policy_group_name | The name of a policy-group of a workload. |
| Policy_group_uuid | The UUID (unique identifier) of the policy-group of a |
| | workload. |
| Data_object_type | The data object type on which a workload is defined, for |
| | example, one of vserver, volume, LUN, file or node. |
| Data_object_name | The name of the lowest-level data object, which is part of an |
| | instance name as discussed above. When data_object_type is a |
| | file, this will be the name of the file relative to its |
| | volume. |
| Data_object_uuid | The UUID of a vserver, volume or LUN on which this data object |
| | is defined. |
| Data_object_file_handle | The file handle of the file on which this data object is |
| | defined; or empty if data_object_type is not a file. |

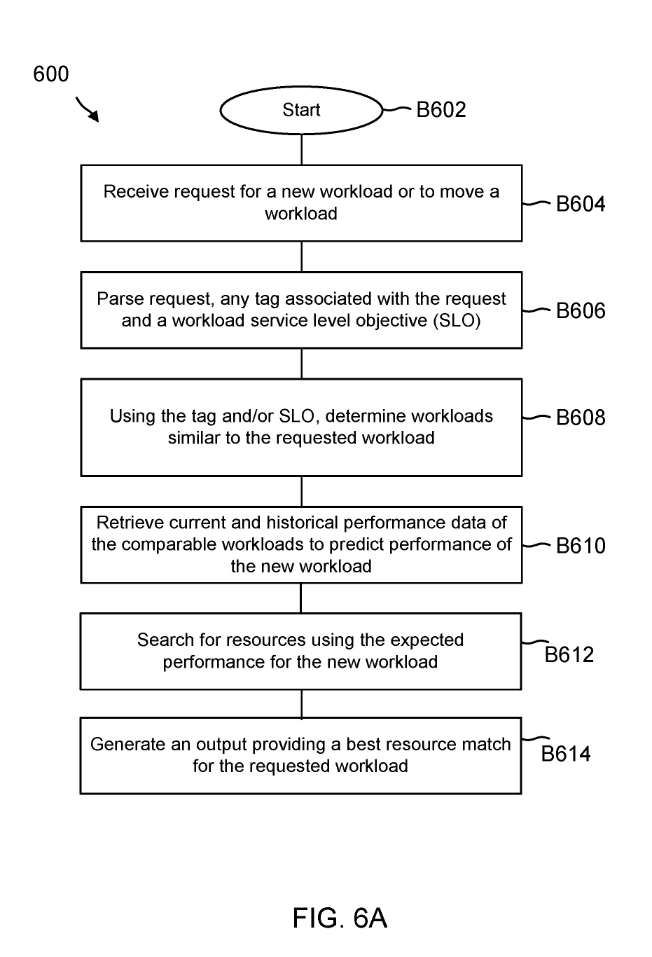

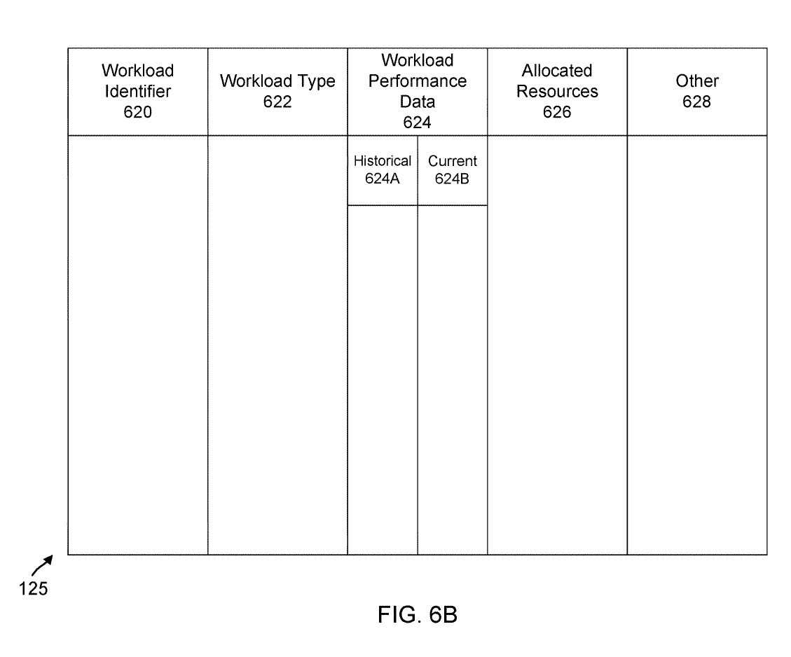

Process Flow: FIG. 6A shows a process 600 for using comparable workload performance data to configure new workloads or to move an existing workload from one volume to another volume, according to one aspect. The process begins in block B602 when performance manager 121, collection module 211 and the various storage clusters are all operational.

In block B604, a request is received for a new workload or to move a workload to a new volume. The workload request includes a tag, an expected utilization, latency and/or a throughput rate. The request may also indicate a service level objective (SLO), where the SLO is associated with a guaranteed storage service level, for example, a guaranteed latency, utilization and/or throughput. The tag in the workload request provides a descriptor for classifying and describing a workload type. For example, the tag may indicate that the workload request is for a “Microsoft Outlook Email Server” as the workload type.

In block B606, the comparable generator 223 of the performance manager 121 parses the request. The workload type information is obtained from the tag and the expected performance parameters are determined based on any SLO or information from the request.

In block B608, using the tag information, the comparable generator 223 determines a workload that is comparable to the requested workload. In one aspect, the comparable generator 223 uses the data structure 125 shown in FIG. 6B to identify the comparable workload. Once the comparable workload is identified, the comparable generator 223 obtains the current and historical performance data to predict the performance of the requested workload.

In one aspect, the performance module 121 obtains QOS data for the comparable workloads from the collection module 211. The QOS data regarding one or more clusters is initially collected by the QOS module 109 based on the configuration of the service centers and delay centers that are involved in processing I/O requests for each workload. The QOS data includes response time, service time per visit, wait time per visit, the number of visits within a duration (for example, a second) and a number of operations performed by a workload. The QOS data is pre-processed by the collection module 211 and then provided to performance module 121.

When a minimum amount of QOS data is available, then the QOS data for one or more workload is retrieved by the analysis module 225. The QOS data may be stored at a storage location that is accessible directly or indirectly by the analysis module.

In one aspect, the analysis module 225 may be used to determine coefficients for predicting the expected performance of the requested workload. In one aspect, a linear prediction mathematical model may be used to provide the expected range using coefficients for the collected QOS data 125. An example of the linear prediction mathematical model is provided below:

### Prediction:

Given y₀, y₁, y₂, y₃, . . . , yₙ₋₁

Solve for dⱼ, yₙ=Σⱼ₌₁ⁿdⱼyₙ₋ⱼ+x

Minimize mean square error

$$\begin{matrix}< {( {y}_{n} - {\sum }_{j = 1}^{n} {d}_{j} {y}_{n - j} )}^{2} >= \text{?} \\ < ( {y}_{n}^{2} - 2 {\sum }_{j = 1}^{n} {d}_{j} {y}_{n} {y}_{n - j} + {\sum }_{j , k} {d}_{j} {d}_{k} {y}_{n - j} {y}_{n - k} ) > \\ = < {y}_{n}^{2} > - 2 {\sum }_{j = 1}^{n} {d}_{j} < {y}_{n} {y}_{n - j} > + \\ {\sum }_{j , k} {d}_{j} {d}_{k} < {y}_{n - j} {y}_{n - k} >\end{matrix}$$

$$\text{?} \text{indicates text missing or illegible when filed}$$

Take derivative wrt dⱼ:

$$- 2 < {y}_{n} {y}_{n - j} > + 2 {\sum }_{k} {d}_{k} < {y}_{n - j} {y}_{n - k} >= 0$$

$${\sum }_{k} {d}_{k} < {y}_{n - j} {y}_{n - k} >= < {y}_{n} {y}_{n - j} > \\ {\sum }_{k} {d}_{k} γ ( \vert j - k \vert ) = γ ( j )$$

In the above description, angle brackets indicate statistical averages. The gamma function stands for autocorrelation. A certain amount of QOS data (for example, 15 days' of data) may be used to calibrate the linear prediction model. The data is used to solve for the coefficients (d) in the above equations. The coefficients are used to predict the performance of the requested workload.

It is noteworthy that the linear prediction mathematical model described above is one technique to predict future behavior. Other mathematical techniques, for example, Kalman filter (linear quadratic estimation), may be used to provide the expected performance of the requested workload.

In block B612, the comparable generator 223 obtains resources using the expected performance for the requested workload. This information may also be stored at data structure 125 as well as data structure 111 maintained by the storage system. Data structure 125 identifies the various storage resources, for example, nodes, storage devices and others. A performance parameter is associated with each resource where the performance parameter indicates latency, utilization and throughput associated with the resource.

Based on the resource information, in block B614, an output is generated by the comparable generator 223 that provides a best resource match for the requested workload. The output identifies a storage system node, an aggregate, a storage LUN or volume, a read/write ratio, as well as a graphical display of with a curve fit for utilization, latency and IOPS.

FIG. 6B shows an example of data structure 125 that is used by the comparable generator 223 and populated by the analysis module 225, according to one aspect. Although the example is shown as a table, any format maybe used for storing comparable workload performance data.

Data structure 125 stores information regarding a plurality of workloads identified by a workload identifier 620. The workload type 622 identifies the workload type. This information is indicated by the tag. The workload performance data 624 includes the historical data 624A and current data 624B. The resources 626 allocated to the workload are identified, which may include the storage system nodes, volumes, aggregates and other resource types.

Data structure 125 may also store other information 628 that may be used to find comparable workloads. For example, the other information may store SLO levels for the resources/workloads. The SLO level indicates the storage service level for a workload. For example, a higher service level may provide lower latency and a lower service level may provide higher latency.

In one aspect, methods and systems for a networked storage system are provided. One method includes receiving a request for configuring a workload by a processor executing a management application in a networked storage system, the request including a tag with information for identifying a workload type and information defining an expected performance characteristic of the workload; determining by the processor a comparable workload using the tag information; obtaining by the processor current and historical performance data associated with the comparable workload; estimating by the processor performance characteristic of the requested workload using performance data of the comparable workload; identifying by the processor a resource of the networked storage system that meets the estimated performance characteristic; and allocating by the processor the resource to the requested workload.

In one aspect, the systems and process described above, improves computing abilities and data storage because the hardware executed comparable generator 223 is able to identify comparable workloads, determines an expected performance and match the workload with an appropriate resource. This technological improvement enhances user applications and computing devices that use the networked storage system to store and retrieve data.

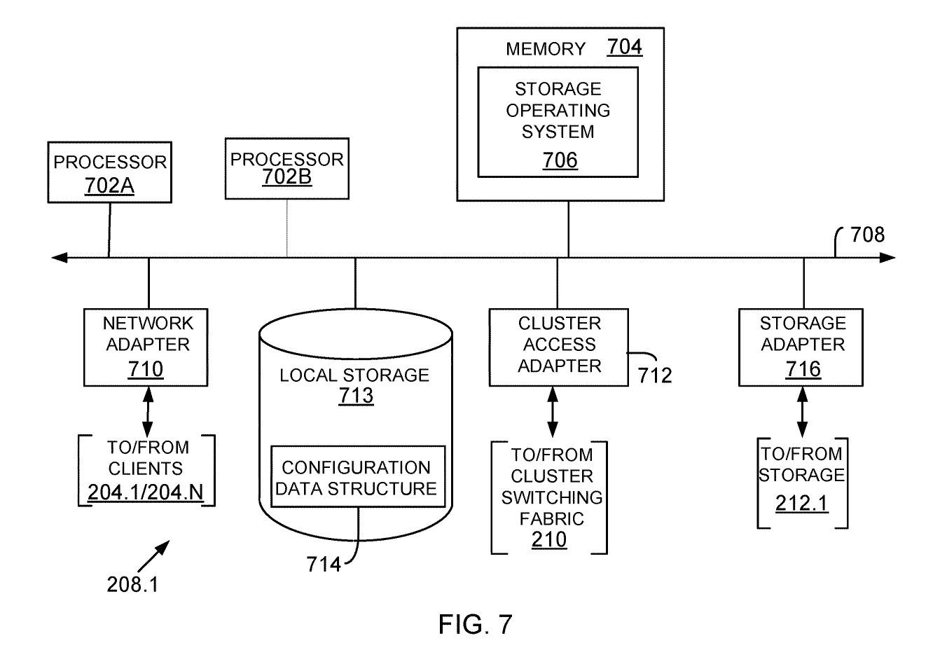

Storage System Node: FIG. 7 is a block diagram of a node 208.1 that is illustratively embodied as a storage system comprising of a plurality of processors 702A and 702B, a memory 704, a network adapter 710, a cluster access adapter 712, a storage adapter 716 and local storage 717 interconnected by a system bus 708. Node 208.1 may be used to provide QOS information to performance manager 121 described above.

Processors 702A-702B may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware devices. The local storage 713 comprises one or more storage devices utilized by the node to locally store configuration information for example, in a configuration data structure 714. The configuration information may include information regarding storage volumes and the QOS associated with each storage volume.

The cluster access adapter 712 comprises a plurality of ports adapted to couple node 208.1 to other nodes of cluster 202. In the illustrative aspect, Ethernet may be used as the clustering protocol and interconnect media, although it will be apparent to those skilled in the art that other types of protocols and interconnects may be utilized within the cluster architecture described herein. In alternate aspects where the network modules and storage modules are implemented on separate storage systems or computers, the cluster access adapter 712 is utilized by the network/storage module for communicating with other network/storage modules in the cluster 202.

Each node 208.1 is illustratively embodied as a dual processor storage system executing a storage operating system 706 (similar to 107, FIG. 1) that preferably implements a high-level module, such as a file system, to logically organize the information as a hierarchical structure of named directories and files at storage 212.1. However, it will be apparent to those of ordinary skill in the art that the node 208.1 may alternatively comprise a single or more than two processor systems. Illustratively, one processor 702A executes the functions of the network module on the node, while the other processor 702B executes the functions of the storage module.

The memory 704 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the disclosure described herein.

The storage operating system 706 portions of which is typically resident in memory and executed by the processing elements, functionally organizes the node 208.1 by, inter alia, invoking storage operation in support of the storage service implemented by the node.

The network adapter 710 comprises a plurality of ports adapted to couple the node 208.1 to one or more clients 204.1/204.N over point-to-point links, wide area networks, virtual private networks implemented over a public network (Internet) or a shared local area network. The network adapter 710 thus may comprise the mechanical, electrical and signaling circuitry needed to connect the node to the network. Each client 204.1/204.N may communicate with the node over network 206 (FIG. 2A) by exchanging discrete frames or packets of data according to pre-defined protocols, such as TCP/IP.

The storage adapter 716 cooperates with the storage operating system 706 executing on the node 208.1 to access information requested by the clients. The information may be stored on any type of attached array of writable storage device media such as video tape, optical, DVD, magnetic tape, bubble memory, electronic random access memory, micro-electro mechanical and any other similar media adapted to store information, including data and parity information. However, as illustratively described herein, the information is preferably stored at storage device 212.1. The storage adapter 716 comprises a plurality of ports having input/output (I/O) interface circuitry that couples to the storage devices over an I/O interconnect arrangement, such as a conventional high-performance, Fibre Channel link topology.

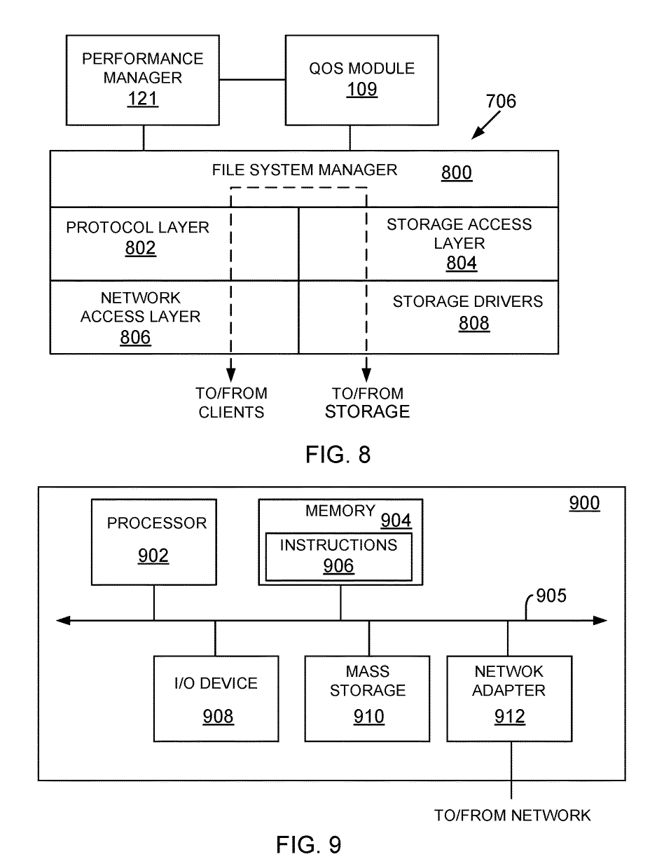

Operating System: FIG. 8 illustrates a generic example of storage operating system 706 (or 107, FIG. 1) executed by node 208.1, according to one aspect of the present disclosure. The storage operating system 706 interfaces with the QOS module 109 and the performance manager 121 such that proper bandwidth and QOS policies are implemented at the storage volume level.

In one example, storage operating system 706 may include several modules, or “layers” executed by one or both of network module 214 and storage module 216. These layers include a file system manager 800 that keeps track of a directory structure (hierarchy) of the data stored in storage devices and manages read/write operation, i.e. executes read/write operation on storage in response to client 204.1/204.N requests.

Storage operating system 706 may also include a protocol layer 802 and an associated network access layer 806, to allow node 208.1 to communicate over a network with other systems, such as clients 204.1/204.N. Protocol layer 802 may implement one or more of various higher-level network protocols, such as NFS, CIFS, Hypertext Transfer Protocol (HTTP), TCP/IP and others.

Network access layer 806 may include one or more drivers, which implement one or more lower-level protocols to communicate over the network, such as Ethernet. Interactions between clients' and mass storage devices 212.1-212.3 (or 114) are illustrated schematically as a path, which illustrates the flow of data through storage operating system 706.

The storage operating system 706 may also include a storage access layer 804 and an associated storage driver layer 808 to allow storage module 216 to communicate with a storage device. The storage access layer 804 may implement a higher-level storage protocol, such as RAID (redundant array of inexpensive disks), while the storage driver layer 808 may implement a lower-level storage device access protocol, such as Fibre Channel or SCSI. The storage driver layer 808 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a node 208.1, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly-attached to a client or host computer. The term “storage system” should therefore be taken broadly to include such arrangements in addition to any subsystems configured to perform a storage function and associated with other equipment or systems. It should be noted that while this description is written in terms of a write any where file system, the teachings of the present disclosure may be utilized with any suitable file system, including a write in place file system.

Processing System: FIG. 9 is a high-level block diagram showing an example of the architecture of a processing system 900 that may be used according to one aspect. The processing system 900 can represent performance manager 121, host system 102, management console 118, clients 116, 204, or storage system 108. Note that certain standard and well-known components which are not germane to the present aspects are not shown in FIG. 9.

The processing system 900 includes one or more processor(s) 902 and memory 904, coupled to a bus system 905. The bus system 905 shown in FIG. 9 is an abstraction that represents any one or more separate physical buses and/or point-to-point connections, connected by appropriate bridges, adapters and/or controllers. The bus system 905, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processor(s) 902 are the central processing units (CPUs) of the processing system 900 and, thus, control its overall operation. In certain aspects, the processors 902 accomplish this by executing software stored in memory 904. A processor 902 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 904 represents any form of random access memory (RAM), read-only memory (ROM), flash memory, or the like, or a combination of such devices. Memory 904 includes the main memory of the processing system 900. Instructions 906 implement the process steps described above may reside in and executed by processors 902 from memory 904. For example, instructions 906 may be used to implement the process of FIG. 6A, comparable generator 223 and the analysis module 225 as well as data structure 125, according to one aspect.

Also connected to the processors 902 through the bus system 905 are one or more internal mass storage devices 910, and a network adapter 912. Internal mass storage devices 910 may be, or may include any conventional medium for storing large volumes of data in a non-volatile manner, such as one or more magnetic or optical based disks. The network adapter 912 provides the processing system 900 with the ability to communicate with remote devices (e.g., storage servers) over a network and may be, for example, an Ethernet adapter, a Fibre Channel adapter, or the like.

The processing system 900 also includes one or more input/output (I/O) devices 908 coupled to the bus system 905. The I/O devices 908 may include, for example, a display device, a keyboard, a mouse, etc.

Thus, a method and apparatus for configuring workloads in a networked storage environment have been described. Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A method, comprising:
receiving a request for configuring a workload by a processor executing a management application in a networked storage system, the request including a tag with information for identifying a workload type and information defining an expected performance characteristic of the workload;
determining by the processor a comparable workload using the tag information;
obtaining by the processor current and historical performance data associated with the comparable workload;
estimating by the processor performance characteristic of the requested workload using performance data of the comparable workload;
identifying by the processor a resource of the networked storage system that meets the estimated performance characteristic; and
allocating by the processor the resource to the requested workload.

2. The method of claim 1, wherein the expected performance characteristic specifies an expected latency for the requested workload.

3. The method of claim 1, wherein the expected performance characteristic specifies an expected utilization of a storage device used for the workload.

4. The method of claim 1, wherein the expected performance characteristic specifies a number of input/output operations executed per second (IOPS) for the requested workload.

5. The method of claim 1, wherein the request includes a service level objective that defines performance characteristics for the workload.

6. The method of claim 1, wherein the allocated resource is an aggregate having one or more storage devices of the networked storage system.

7. The method of claim 1, wherein the allocated resource is a storage volume managed by a node of the networked storage system.

8. A non-transitory, machine readable storage medium having stored thereon instructions for performing a method, comprising machine executable code which when executed by at least one machine, causes the machine to:
receive a request for configuring a workload by a processor executing a management application in a networked storage system, the request including a tag with information for identifying a workload type and information defining an expected performance characteristic of the workload;
determine a comparable workload using the tag information;
obtain current and historical performance data associated with the comparable workload;
estimate performance characteristic of the requested workload using performance data of the comparable workload;
identify a resource of the networked storage system that meets the estimated performance characteristic; and
allocate the resource to the requested workload.

9. The non-transitory, machine readable storage medium of claim 8, wherein the expected performance characteristic specifies an expected latency for the requested workload.

10. The non-transitory, machine readable storage medium of claim 8, wherein the expected performance characteristic specifies an expected utilization of a storage device used for the workload.

11. The non-transitory, machine readable storage medium of claim 8, wherein the expected performance characteristic specifies a number of input/output operations executed per second (IOPS) for the requested workload.

12. The non-transitory, machine readable storage medium of claim 8, wherein the request includes a service level objective that defines performance characteristics for the workload.

13. The non-transitory, machine readable storage medium of claim 8, wherein the allocated resource is an aggregate having one or more storage devices of the networked storage system.

14. The non-transitory, machine readable storage medium of claim 8, wherein the allocated resource is a storage volume managed by a node of the networked storage system.

15. A system, comprising:
a memory containing machine readable medium comprising machine executable code having stored thereon instructions; and a processor module of a management console of a networked storage system coupled to the memory, the processor module configured to execute the machine executable code to:
receive a request for configuring a workload, the request including a tag with information for identifying a workload type and information defining an expected performance characteristic of the workload; determine a comparable workload using the tag information;
obtain current and historical performance data associated with the comparable workload;
estimate performance characteristic of the requested workload using performance data of the comparable workload;
identify a resource of the networked storage system that meets the estimated performance characteristic; and
allocate the resource to the requested workload.

16. The system of claim 15, wherein the expected performance characteristic specifies an expected latency for the requested workload.

17. The system of claim 15, wherein the expected performance characteristic specifies an expected utilization of a storage device used for the workload.

18. The system of claim 15, wherein the expected performance characteristic specifies a number of input/output operations executed per second (IOPS) for the requested workload.

19. The system of claim 15, wherein the request includes a service level objective that defines performance characteristics for the workload.

20. The system of claim 15, wherein the allocated resource is a storage volume managed by a node of the networked storage system.
